(19) United States
(12) Patent Application Publication
(10) Pub. No.: US 2012/0090102 A1
(43) Pub. Date: Apr. 19, 2012

(54) ANIONIC DYE POLYMERS

(76) Inventors: Stephen Norman Batchelor, Wirral (GB); Jayne Michelle Bird, Wirral (GB); Wei Chen, Shanghai (CN); Qingsheng Tao, Shanghai (CN); Jinfang Wang, Shanghai (CN)

(21) Appl. No.: 13/377,590

(22) PCT Filed: May 7, 2010
(86) PCT No.: PCT/EP10/56230

§ 371 Date: Dec. 12, 2011

(30) Foreign Application Priority Data
Jun. 15, 2009 (EP) 09162671.3

(51) Int. Cl. C11D 3/42; C09B 1/16; D06L 1/16

(52) U.S. Cl. 8/137; 510/324; 552/228

(57) ABSTRACT

The present invention provides a laundry treatment composition comprising an anionic dye-polymer.

### FIELD OF INVENTION

The present invention relates to the delivery of dyes polymers to fabrics.

### BACKGROUND OF THE INVENTION

WO2005/003274, to Unilever, discloses that shading dyes may be included in detergent formulations to enhance the whiteness of garments.

WO2006/055787 and WO2009/040731, to Proctor and Gamble, discloses anionic reactive dyes bound to polysaccharide polymers for use in laundry formulations. The reactive dyes used are negatively charged. The shading benefit is found predominately on cellulosic garments. It is synthetically difficult and expensive to make such polymers with high dye levels incorporated.

U.S. Pat. No. 3,232,691 discloses an industrial process for simultaneous dyeing and finishing of textiles with a various coloured polymeric dyes in a dispersion; The process requires a heat treatment above 100° C. The dying process disclosed in U.S. Pat. No. 3,232,691 is permanent.

### SUMMARY OF THE INVENTION

The present invention provides dye polymers having dye moieties carrying negatively charged groups. The dye polymers are relatively easy to make and weight effective for shading fabrics. The dye polymers may carry high levels of dye. The dye polymers are labile from cellulosic fabrics and do not build up substantially with the number of washes.

In one aspect the present invention provides a laundry detergent composition comprising from 2 to 70 wt % of a surfactant together with from 0.0001 to 50 wt %, preferably 0.0005 to 10 wt %, of a blue or violet dye-polymer of molecular weight of at least 500, wherein the dye-polymer is obtainable by polymerisation of:
(a) a dye monomer, the dye monomer an alkene covalently bound to a dye, the dye covalently bound to a group selected from: SO₃⁻ and CO₂⁻, the dye monomer having a molar extinction coefficient at a wavelength in the range 400 to 700 nm, preferably 500 to 650 nm, most preferably 540 to 600 nm, of at least 1000 mol⁻¹ L cm⁻¹, preferably greater than 4000 mol⁻¹ L cm⁻¹, and
(b) one or more further alkene comonomer(s), the alkene monomer(s) having molar extinction coefficient at a wavelength in the range 400 to 700 nm that is less than 100 mol⁻¹ L cm⁻¹, preferably less than 10 mol⁻¹ L cm⁻¹.

The dye monomer has at least one SO₃⁻ and/or CO₂⁻ group. The dye monomer may have more than one SO₃⁻ and/or CO₂⁻ group. Preferably the dye monomer has one, two or three SO₃⁻ groups. When the dye monomer is an anthraquinone it preferably carries only one SO₃⁻.

The dye-polymer may be derived from a mixture of different dye monomer, for example carrying different dye chromophores.

In another aspect the present invention provides a domestic method of treating a textile, the method comprising the steps of:
(i) treating a textile with an aqueous solution of the dye-polymer, the aqueous solution comprising from 10 ppb to 100 ppm of the dye-polymer (preferably 0.1 to 5 ppm, most preferably 0.5 to 2 ppm); and, from 0.0 g/L to 3 g/L, preferably 0.3 to 2 g/L, of a surfactant;
(ii) optionally rinsing; and,
(iii) drying the textile.

### DETAILED DESCRIPTION OF THE INVENTION

The detergent composition as described herein is most preferably a granular detergent composition.

### Dye Monomer

The dye monomer is an organic molecule which when dissolved in an organic solvent has a molar absorption extinction coefficient of at least 1000 mol⁻¹ L cm⁻¹, preferably greater than 4000 mol⁻¹ L cm⁻¹ at a wavelength in the range 400 to 700 nm, preferably 500 to 650 nm, most preferably 540 to 600 nm.

Molar absorption coefficients are preferably measured in an organic solvent, preferably propan-2-ol, using a 1, 5 or 10 cm cell.

Dyes are described in Industrial Dyes (K. Hunger ed, Wiley VCH 2003, ISBN 3-527-30426-6). Named dyes are those as found in the Color Index; ©2009 Society of Dyers and Colourists and American Association of Textile Chemists and Colorists.

Preferably, the dye monomer is of the form:

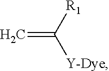

wherein Y is an organic bridging group covalently connecting a dye to the alkene moiety of the dye monomer and R₁ is selected from: alkyl; aryl; benzyl; halogen; ester; acid amide; and, CN. Preferably, when R₁ is a phenyl or benzyl group, the aromatic is not substituted by OH.

Preferably, the Y group is bound directly to a carbon atom of an aromatic ring of the dye.

Preferably, the most direct connection (Y) of an aromatic group of the dye to the alkene carbon carrying R₁ is spaced by 1 to 8 atoms, most preferably 3 to 6; the atoms are preferably selected from: C; N; O; and, S. The alkene may also be directly connected to the dye and in this case Y is absent.

Preferably, the organic bridging group is selected from: —CONR₄—; —NR₄CO—; —COOR₄—; —NR₄—; —O—; —S—; —SO₂—; —SO₂NR₄—; —N(COR₄)—; and —N(SO₂R₄)—; wherein R₄ is selected from: H; C1-C6 branched or linear alkyl; phenyl and benzyl groups; wherein R4 has 0 to 1 spacing units selected from: —O—; —S—; —SO₂⁻; —C(O)O—; —OC(O)—; and an amine. Preferably, the organic bridging group is —NR₄CO—. R₄ is preferably selected: from: H and Me.

The chromophore of the organic dye is preferably selected from the following chromophore classes: anthraquinone; azo; azine; triphenodioxazine; triphenyl methane; xanthene; and, phthalocyanin; most preferred are azo; anthraquinone; and, azine chromophore classes.

R₁ is preferably selected from: H; Me; Et; Pr; CO₂C1-C4 branched and linear alkyl chains; phenyl; benzyl; CN; Cl; and, F. More preferably, R₁ is selected from: H; and, Me.

It is most preferred that the dye-monomer is selected from: acid violet 1; acid violet 3; acid violet 6; acid violet 11; acid violet 13; acid violet 14; acid violet 19; acid violet 20; acid violet 36; acid violet 36:1; acid violet 41; acid violet 42; acid violet 43; acid violet 50; acid violet 51; acid violet 63; acid violet 48; acid blue 25; acid blue 40; acid blue 40:1; acid blue 41; acid blue 43; acid blue 45; acid blue 47; acid blue 49; acid blue 51; acid blue 53; acid blue 56; acid blue 61; acid blue 61:1; acid blue 62; acid blue 69; acid blue 78; acid blue 81:1; acid blue 92; acid blue 96; acid blue 108; acid blue 111; acid blue 215; acid blue 230; acid blue 277; acid blue 344; acid blue 117; acid blue 124; acid blue 129; acid blue 129:1; acid blue 138; acid blue 145; direct violet 99; direct violet 5; direct violet 72; direct violet 16; direct violet 78; direct violet 77; direct violet 83; food black 2; direct blue 33; direct blue 41; direct blue 22; direct blue 71; direct blue 72; direct blue 74; direct blue 75; direct blue 82; direct blue 96; direct blue 110; direct blue 111; direct blue 120; direct blue 120:1; direct blue 121; direct blue 122; direct blue 123; direct blue 124; direct blue 126; direct blue 127; direct blue 128; direct blue 129; direct blue 130; direct blue 132; direct blue 133; direct blue 135; direct blue 138; direct blue 140; direct blue 145; direct blue 148; direct blue 149; direct blue 159; direct blue 162; direct blue 163; and, food black 1 where the acid amide group is replaced by NH₂, wherein the one —NH2 of the dye is converted to —NH—C(O)—CH═CH2 or —NH—C(O)—C(Me)=CH2. The present invention extends to these dye monomers per se.

A preferred class of dye-monomer is selected from the anthraquinione:

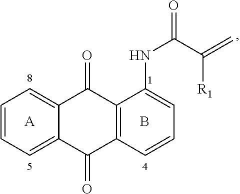

wherein the anthraquinione carries at least one sulphonate.

Of this anthraquinione class it is preferred that the A and B ring are further substituted by one or more groups selected from: NH₂; NHAr; NHR₅; NR₅R₆; OH; Cl; Br, CN, OAr; NO₂; SO₂OAr; Me; and, NHCOC(R1)=CH₂, wherein R₅ and R₆ are independently selected from C1-C8 branched, cyclic or linear alkyl which may be substituted by OH, OMe, Cl or CN. Further, it is preferred that in this anthraquinione class the dye has one SO₃⁻ group and the SO₃⁻ group is at the 2 position. In addition, it is preferred that in this anthraquinione class the 4 position is substituted with a substituent selected from: NH₂; NHR₅; NHAr, where Ar is phenyl or substituted phenyl, and the 5 and 8 position are H.

Preferred dye monomers include:

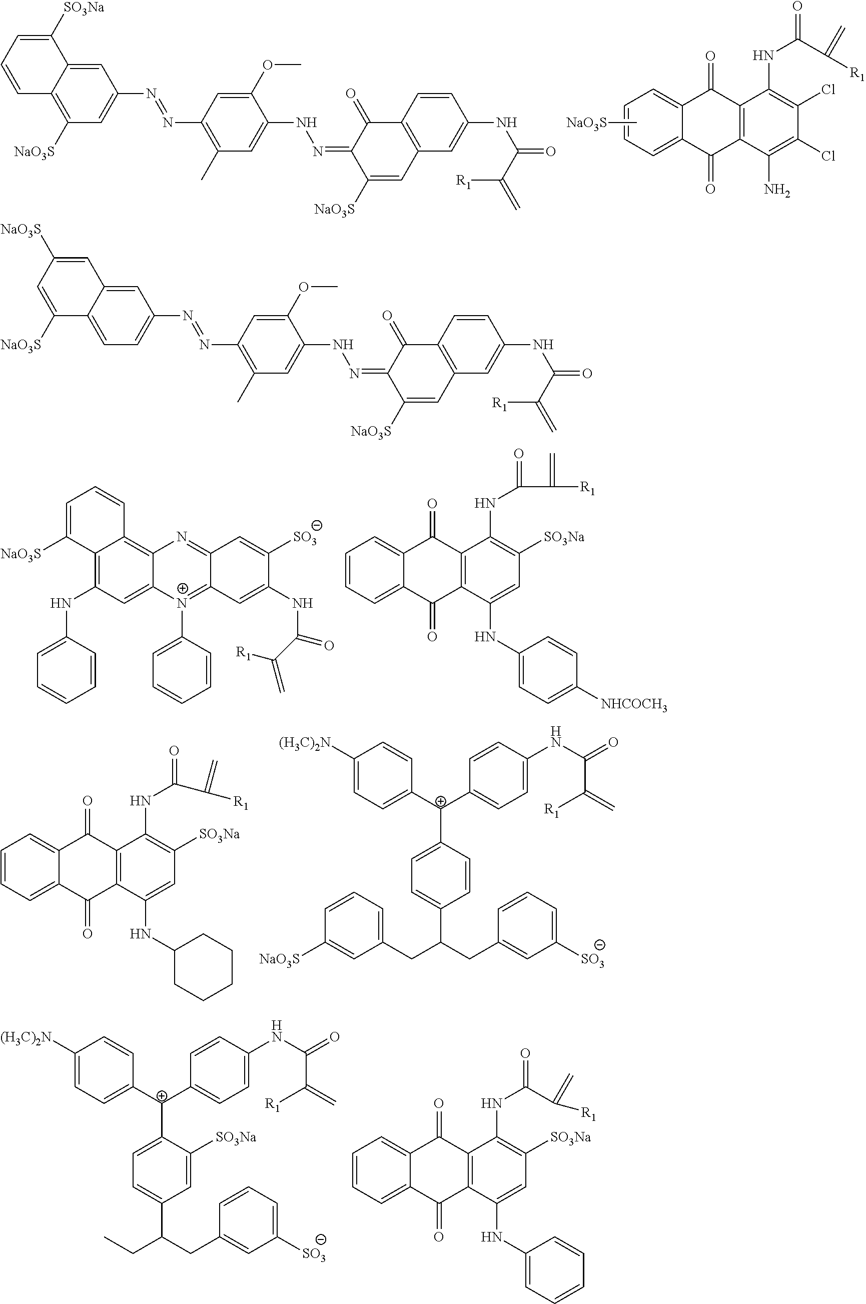

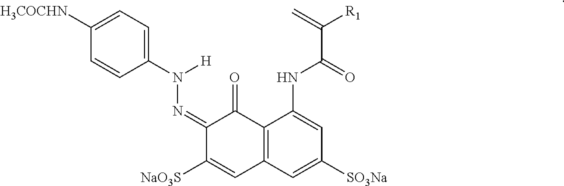

Most preferably the dye is an anthraquinone.

### Alkene Comonomers

The alkene co-monomer may be selected from any suitable alkene. The comonomer is preferably of the form:

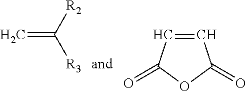

wherein R₂ and R₃ are independently selected from:
H, C1-C8 branched, cyclic and linear alkyl chains, C(O)OH, CO₂C1-C18 branched and linear alkyl chains, —C(O)N(C1-C18)2; —C(O)N(C1-C18)H; —C(O)NH2; heteroaromatic, phenyl, benzyl, polyether, cyano, Cl and F. Where C1-C18 is specified a preferred range is C1 to C4.

The R₂ and R₃ of the comonomer may be further substituted by charged and uncharged organic groups having a total molecular weight of less than 400. Preferred uncharged organic groups are selected from: NHCOCH₃, CH₃, C₂H₅, OH, CH₃O, C₂H₅O, amine, Cl, F, Br, I, NO₂, CH₃SO₂, and CN.

The phenyl, benzyl and alkyl chains may be substituted by further organic groups selected from: OH; F; Cl; alkoxy (preferably OCH₃), SO₃⁻, COOH, amine, quaternary amine, acid amide and ester. When phenyl or benzyl groups are present, the aromatic is not substituted by OH.

Examples of suitable co-monomers include. Examples of suitable co-monomers include. Preferred co-monomer are indicated.

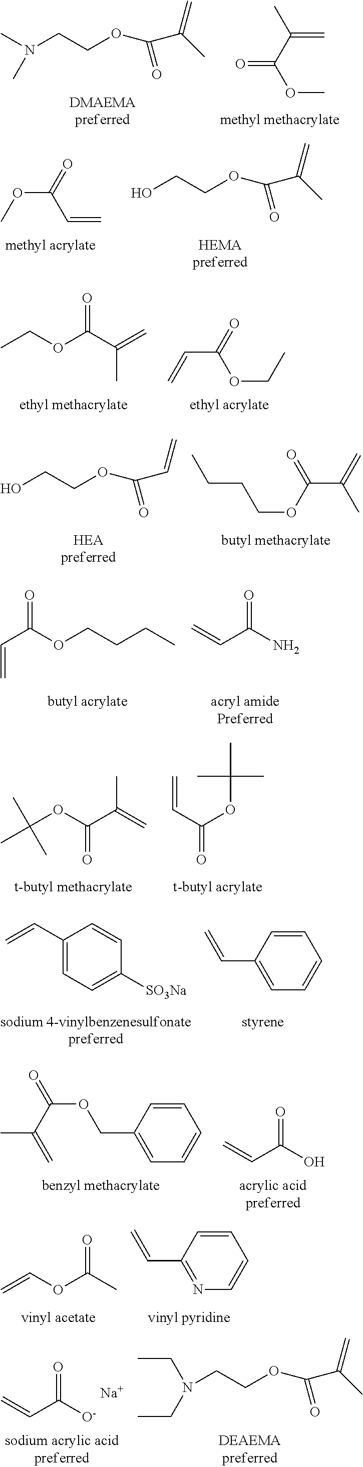

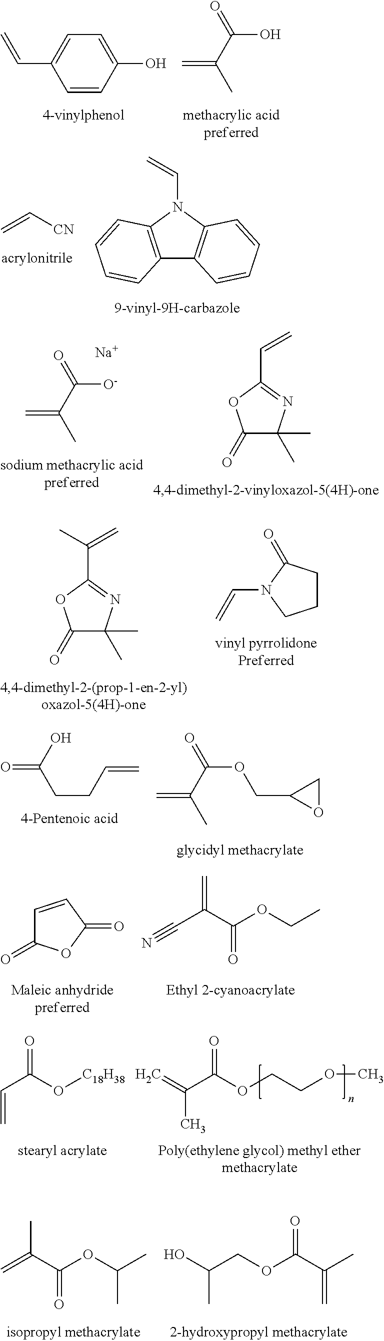

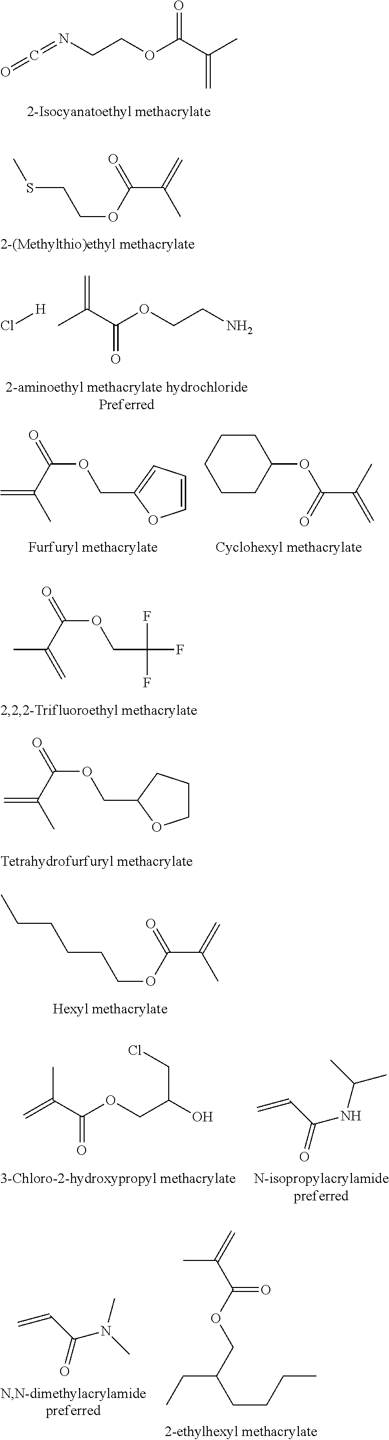

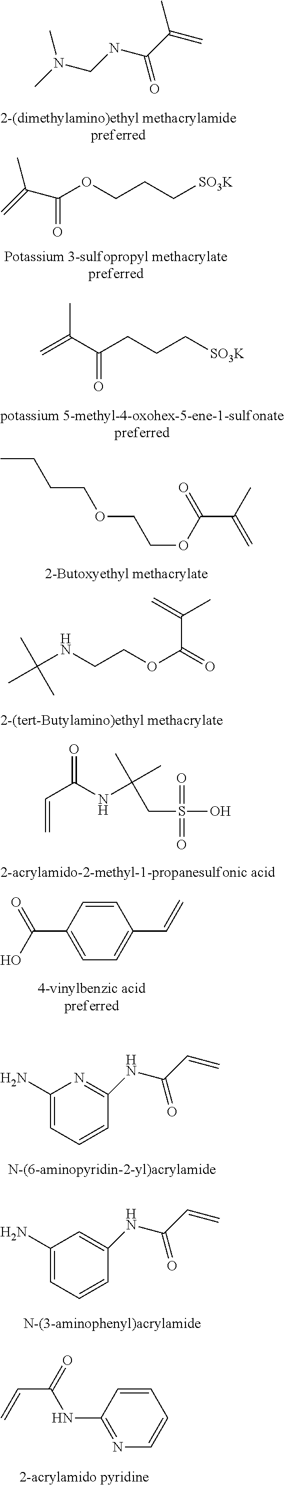

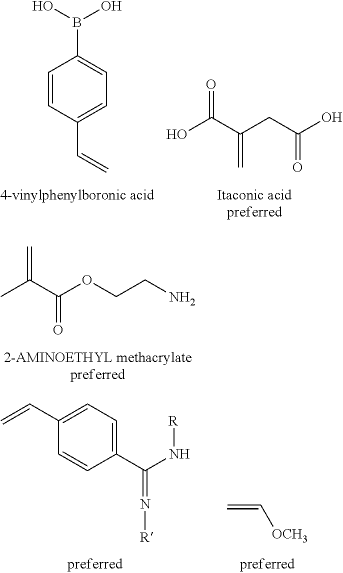

Mixtures of co-monomer may be used. It is preferred that the >50 wt %, more preferably >80 wt %, of the co-monomers are selected from co-monomer that have a molecular weight of less than 300 and contains an amine, amide, OH, OCH₃ SO₃⁻ or COO⁻ group. Most preferably, the co-monomers contain an amine or OCH₃ group.

Most preferably >50 wt % of the comonomers are acrylates with pendant tertiary amine groups, most preferably selected from DMAEMA and DEAEMA.

Additional co-monomer may be added to the polymer which are covalently bound to radical photobleaches such as vitamin K3 or 2-ethyl anthraquinone. Other organic active ingredients such as sunscreens, antifungal agents, bleach catalysts, antimicrobial, antiwrinkle may also be covalently linked to the polymer. Examples of such ingredients are 5-chloro-2-(2,4-dichlorophenoxy)phenol, 6-acetoxy-2,4-dimethyl-m-dioxane, para-aminobenzoic acid, diethanolamine-p-methoxy cinnamate and oxybenzone. Most preferably the ingredient contains an NH₂ group and the monomer is created in an analogous manner to the dye monomer. These are preferably present at a lower level than the dye.

### Dye Polymer

Preferably, the dye polymer is blue or violet in colour. Preferably the dye polymer gives a blue or violet colour to the cloth with a hue angle of 250 to 345, more preferably 265 to 330, most preferably 270 to 300. The cloth used to determine the hue angle is white bleached non-mercerised woven cotton sheeting.

The polymer is obtainable by co-polymerisation of the dye monomer with suitable unsaturated organic co-monomers.

Preferably the polymer contains 0.1 to 30 Molar % dye monomers units, more preferably 1 to 15 Molar % dye monomers units, most preferably 2 to 10 Molar %.

Preferably the polymer contains less than 20 Molar %, more preferably less than 5 Molar % of co-monomers bearing COOH or SO₃⁻ groups.

The monomers within the polymer may be arranged in any suitable manner. For example as Alternating copolymers possess regularly alternating monomer residues; Periodic copolymers have monomer residue types arranged in a repeating sequence; Random copolymers have a random sequence of monomer residue types; Statistical copolymers have monomer residues arranged according to a known statistical rule; Block copolymers have two or more homopolymer subunits linked by covalent bonds. Most preferably the polymer is a random copolymer. The polymer should have a molecular weight 500 and greater, preferably 2000 and greater, preferably 5000 and greater. In this context the molecular weight is the number average molecular weight. This is the ordinary arithmetic mean of the molecular weights of the individual macromolecules. It is determined by measuring the molecular weight of j polymer molecules, summing the weights, and dividing by j. Molecular weights are determined by Gel Permeations Chromatography.

It is preferred that the dye-polymer is soluble in surfactant solution. Specifically that at 1 g/L sodium dodecyl sulfate aqueous solution at pH=7 the dye polymer has a solubility of greater than 1 mg/L, preferably greater than 10 mg/L. Water solubility is enhanced by the presence of hydroxy, amino and charged groups in the polymer, preferably anionic charged groups.

Preferably the polymer is of the form:

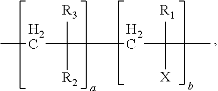

wherein X=Y-Dye. Preferably, a is greater than b (a>b). More preferably the ratio a:b is from 99.9:0.1 to 70:30.

It is preferred that the dye-polymer has a number average molecular weight in the range from 500 to 500000, preferably from 1000 to 100000, more preferably 5000 to 50000.

For addition to a granular formulation the polymer dye may be added to the slurry to be spray dried or preferably added via post-dosed granules.

In a preferred embodiment the polymer dye powder obtained from the polymer dye synthesis is mixed with a Na₂SO₄ or NaCl or pre-prepared granular base or full detergent formulation to give a 0.1 to 20 polymer dye wt % mixture. This dry mix is then mixed into the granular formulation. The polymer dye powder is preferably formed by drying a liquid slurry or solution of the dye, for example by vacuum drying, freeze drying, drying in drum dryers, Spin Flash® (Anhydro), but most preferably by spray drying. The polymer dye powder may be ground before, during or after the making of the slurry. This grinding is preferably accomplished in mills, such as for example ball, swing, bead or sand mills, or in kneaders. Other ingredients such as dispersants or alkali metal salts may be added to the liquid slurry. The polymer dye powder preferably contains 20 to 100 wt % of the dye.

Preferably, the polymer dye powder has an average particle size, APS, from 0.1 to 300 microns, preferably 10 to 100 microns. Preferably this is as measured by a laser diffraction particle size analyser, preferably a Malvern HP with 100 mm lens.

### Surfactant

The composition comprises between 2 to 70 wt percent of a surfactant, most preferably 10 to 30 wt %. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆ to C₂₂ alkyl phenol-ethylene oxide condensates, generally 5 to 25 EO, i.e. 5 to 25 units of ethylene oxide per molecule, and the condensation products of aliphatic C₈ to C₂₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈ to C₂₈ alcohols, produced for example from tallow or coconut oil, sodium and potassium alkyl C₉ to C₂₀ benzene sulphonates, particularly sodium linear secondary alkyl C₁₀ to C₂₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁ to C₁₅ alkyl benzene sulphonates and sodium C₁₂ to C₁₈ alkyl sulphates. Also applicable are surfactants such as those described in EP-A-328 177 (Unilever), which shows resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆ to C₁₈ primary alcohol sulphate together with a C₁₂ to C₁₅ primary alcohol 3 to 7 EO ethoxylate.

The nonionic detergent is preferably present in amounts greater than 10%, e.g. 25 to 90 wt % of the surfactant system. Anionic surfactants can be present for example in amounts in the range from about 5% to about 40 wt % of the surfactant system.

In another aspect which is also preferred the surfactant may be a cationic such that the formulation is a fabric conditioner.

### Cationic Compound

When the present invention is used as a fabric conditioner it needs to contain a cationic compound.

Most preferred are quaternary ammonium compounds.

It is advantageous if the quaternary ammonium compound is a quaternary ammonium compound having at least one C₁₂ to C₂₂ alkyl chain.

It is preferred if the quaternary ammonium compound has the following formula:

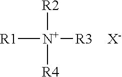

in which R¹ is a C₁₂ to C₂₂ alkyl or alkenyl chain; R², R³ and R⁴ are independently selected from C₁ to C₄ alkyl chains and X⁻ is a compatible anion. A preferred compound of this type is the quaternary ammonium compound cetyl trimethyl quaternary ammonium bromide.

A second class of materials for use with the present invention are the quaternary ammonium of the above structure in which R¹ and R² are independently selected from C₁₂ to C₂₂ alkyl or alkenyl chain; R³ and R⁴ are independently selected from C₁ to C₄ alkyl chains and X⁻ is a compatible anion.

A detergent composition according to claim 1 in which the ratio of (ii) cationic material to (iv) anionic surfactant is at least 2:1.

Other suitable quaternary ammonium compounds are disclosed in EP 0 239 910 (Proctor and Gamble).

It is preferred if the ratio of cationic to nonionic surfactant is from 1:100 to 50:50, more preferably 1:50 to 20:50.

The cationic compound may be present from 1.5 wt % to 50 wt % of the total weight of the composition. Preferably the cationic compound may be present from 2 wt % to 25 wt %, a more preferred composition range is from 5 wt % to 20 wt %.

The softening material is preferably present in an amount of from 2 to 60% by weight of the total composition, more preferably from 2 to 40%, most preferably from 3 to 30% by weight.

The composition optionally comprises a silicone.

### Builders or Complexing Agents

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

The composition may also contain 0-65% of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (carbonate (including bicarbonate and sesquicarbonate) are preferred builders.

The composition may contain as builder a crystalline aluminosilicate, preferably an alkali metal aluminosilicate, more preferably a sodium aluminosilicate. This is typically present at a level of less than 15% w. Aluminosilicates are materials having the general formula:

0.8-1.5M₂O.Al₂O₃.0.8-6SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

Preferably the laundry detergent formulation is a non-phosphate built laundry detergent formulation, i.e., contains less than 1 wt % of phosphate.

### Fluorescent Agent

The composition preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl.

It is preferred that the aqueous solution used in the method has a fluorescer present. When a fluorescer is present in the aqueous solution used in the method it is preferably in the range from 0.0001 g/l to 0.1 g/l, preferably 0.001 to 0.02 g/l.

### Perfume

Preferably the composition comprises a perfume. The perfume is preferably in the range from 0.001 to 3 wt %, most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

Perfume and top note may be used to cue the whiteness benefit of the invention.

It is preferred that the laundry treatment composition does not contain a peroxygen bleach, e.g., sodium percarbonate, sodium perborate, and peracid.

### Polymers

The composition may comprise one or more polymers. Examples are carboxymethylcellulose, poly(ethylene glycol), poly(vinyl alcohol), polycarboxylates such as polyacrylates, maleic/acrylic acid copolymers and lauryl methacrylate/acrylic acid copolymers.

Polymers present to prevent dye deposition, for example poly(vinylpyrrolidone), poly(vinylpyridine-N-oxide), and poly(vinylimidazole), are preferably absent from the formulation.

### Enzymes

The laundry treatment composition may contain an enzyme. Preferred enzymes are disclosed in WO 2007/087243 and WO 2007/087257.

### EXAMPLES

### Example 1

### Polymer Synthesis

The dye monomer shown in the scheme below was prepared by the reaction of Acid Blue 25 (CI: 62055) and acryloyl chloride (2-propenoyl chloride) in the presence of sodium dicarbonate. Methacryloyl chloride (2-methylprop-2-enoyl chloride) also functions well to provide similar dye monomers.

Dye polymers were created via radical polymerisation of the dye monomer with dimethyl amino ethyl methacrylate (DMAEMA) according to the reaction scheme:

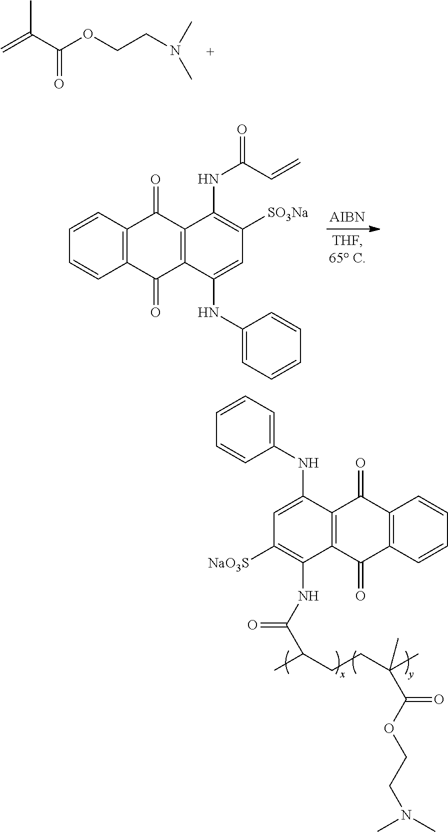

### Example 2

### UV-VIS Spectroscopy

The UV-Vis spectra of the dye polymers of example 1 were recorded in demineralised water at 1 g/L dye polymer. The UV-V is spectra of the dye polymers of example 3 were recorded in demineralised water at 1 g/L dye polymer and containing 1 g/L of linear alkly benzene sulphonate surfactant (LAS). The results are given in the tables below and an identifying code given to each polymer.

| 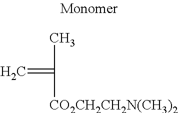 | 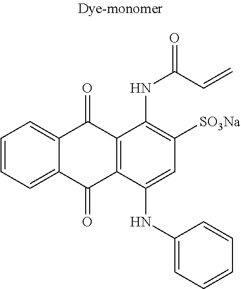 | code | λmax in range 400- 700 nm | Absorbance (1 cm) @ λmax for 1 g/L in 1 g/L LAS |
|---|---|---|---|---|
| 95 | 5 | P4 | 551 | 0.76 |
| 90 | 10 | P5 | 534 | 1.37 |

### Example 3

### Dye Deposition Experiment

Knitted white polyester (microfiber), knitted nylon-elastane (80:20) and white woven non-mercerised cotton fabrics were used together in 4 g/L of a detergent which contained 15% Linear Alkyl benzene sulfonate (LAS) surfactant, 30% Na₂CO₃, 40% NaCl, remainder minors included calcite and fluorescer and moisture. Washes were conducted in 6° French Hard water at room temperature with a liquor to cloth ratio of 30:1, for 30 minutes. This was then repeated once more to accomplish 2 washes in total. Following the washes the cloths were rinsed twice in water, dried, their reflectance spectrum measured on a reflectometer and the colour expressed as CIE L* a* b* values (UV-excluded).

The experiment was repeated with the addition of the dye polymers of example 2. The polymers were added to give 5 ppm in the wash solution. The deposition of the dye-polymers to the fabrics was expressed as the Δb value such that Δb=b(control)−b(dye polymer)+ve values indicate a blueing of the fabric, due to dye-polymer deposition.

| | Δb 2^{nd} wash | | |
|---|---|---|---|
| Dye-polymer | Cotton | Nylon elastane | polyester |
| P4 | 1.2 | 1.8 | 0.2 |
| P5 | 1.1 | 1.1 | 0.3 |

The dye-polymers deposit to nylon-elastane, cotton and polyester fabrics.

An added advantage is that the dye-polymer also facilitates soil removal and alter fabric feel.

### Example 4

### Soil Removal

Knitted white polyester (microfiber), white woven non-mercerised cotton fabrics and a sebum stain monitor [WFK 10 D (Cotton). (Supplied by WFK-Testgewebe GmbH, Adlerstr. 42, D-4150)] were washed together in 4 g/L of a detergent which contained 15% Linear Alkyl benzene sulfonate (LAS) surfactant, 30% Na₂CO₃, 40% NaCl, remainder minors included calcite and fluorescer and moisture. Washes were conducted in 6° French Hard water at room temperature with a liquor to cloth ratio of 30:1, for 30 minutes. Following the washes the cloths were rinsed twice in water, dried, their reflectance spectrum measured on a reflectometer (UV-excluded).

The experiment was repeated with the addition of 1 ppm in the wash solution of dye polymer P4 of example 3.

The soil removal on the WFK10D cloth was measured as the change in % Reflectance at 460 nm before and after washing: ΔR₄₆₀=R₄₆₀ (after wash)−R₄₆₀ (before wash).

The experiments were repeated 4 times and the average values of ΔR₄₆₀ calculated. The results were

ΔR₄₆₀ (control)=5.0

### ΔR₄₆₀ (P4)=5.9

The dye polymer p4 increases the soil removal.

### Exemplary Base Powder Formulations A, B, C and D

| Formulation | A | B | C | D |
|---|---|---|---|---|
| NaLAS | 15 | 20 | 10 | 14 |
| NI (7EO) | — | — | — | 10 |
| Na lauryl sulfate | — | 2 | — | 1 |
| Na tripolyphosphate | — | 15 | — | — |
| Soap | — | — | — | 2 |
| Zeolite A24 | 7 | — | — | 17 |
| Sodium silicate | 5 | 4 | — | 1 |
| Sodium carbonate | 25 | 20 | 30 | 20 |
| Sodium sulphate | 40 | 33 | 40 | 22 |
| Carboxymethyl- | 0.2 | 0.3 | — | 0.5 |
| cellulose | | | | |
| Sodium chloride | — | — | 5 | 5 |
| lipase | 0.005 | 0.01 | — | 0.005 |
| Protease | 0.005 | 0.01 | — | 0.005 |
| Amylase | 0.001 | 0.003 | — | — |
| Cellulase | — | 0.003 | — | — |
| Acid Violet 50 | 0.0015 | 0.0024 | — | — |
| Disperse violet 28 | 0.003 | — | 0.003 | — |
| P4 (see example 2) | 0.0125 | 0.018 | 0.0085 | 0.020 |
| Fluorescer | 0.1 | 0.15 | 0.05 | 0.3 |
| Water/impurities/ | remainder | remainder | remainder | remainder |
| minors | | | | |

Disperse violet 28 is Dianix Brilliant Violet B, ex DyStar, as received.

### Exemplary Base Liquid Formulations A, B, C and D

| Formulation | A | B | C | D |
|---|---|---|---|---|
| NaLAS | 14 | 10 | 15 | 21 |
| NI (7EO) | 10 | 5 | 21 | 15 |
| SLES (3EO) | 7 | 10 | 7 | — |
| Soap | 2 | 4 | 1 | 0 |
| Citric acid | 1 | 1 | — | 1 |
| glycerol | 0 | 1 | 5 | 0 |
| Propylene glycol | 5 | 3 | 0 | 4 |
| Sodium chloride | 1 | — | — | — |
| Amine ethoxylated | 0.5 | 1 | — | — |
| polymers | | | | |
| Triethanol amine | 0 | 0.5 | 3 | 1 |
| perfume | 0.2 | 0.1 | 0.3 | 0.4 |
| Protease | 0.005 | 0.01 | — | 0.005 |
| Amylase | 0.001 | 0.003 | — | — |
| lipase | — | 0.003 | — | — |
| Fluorescer | 0.1 | 0.15 | 0.05 | 0.3 |
| P4 (see example 2) | 0.005 | 0.02 | 0.01 | 0.0125 |
| Solvent Violet 13 | — | 0.0005 | 0 | 0.001 |
| Water/impurities/ | remainder | remainder | remainder | remainder |
| minors | | | | |

For both powder and liquids formulations, enzyme levels are given as percent pure enzyme. NI(7EO) refers to R—(OCH₂CH₂)ₙOH, where R is an alkyl chain of C12 to C15, and n is 7. NaLAS is linear alkyl benzene sulphonate (LAS) and (SLES(3EO)) is C12-C18 alkyl polyethoxylate (3.0) sulphate. Formulations were made using Lipex as the lipase, Savinase and Polarzyme and the protease, Carezyme as the cellulose and Stainzyme as the amylase.

1. A laundry detergent composition comprising from 2 to 70 wt % of a surfactant together with from 0.0001 to 50 wt % of a blue or violet dye-polymer of molecular weight of at least 500, wherein the dye-polymer is obtainable by polymerisation of:
(a) a dye monomer, the dye monomer an alkene covalently bound to a dye, the dye covalently bound to a group selected from: SO₃⁻ and CO₂⁻, the dye monomer having a molar extinction coefficient at a wavelength in the range 400 to 700 nm of at least 1000 mol⁻¹ L cm⁻¹, and
(b) one or more further alkene comonomer(s), the alkene monomer(s) having molar extinction coefficient at a wavelength in the range 400 to 700 nm that is less than 100 mol⁻¹ L cm⁻¹.

2. A detergent composition according to claim 1, wherein the dye monomer is of the form: 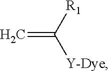
wherein Y is an organic bridging group covalently connecting a dye to the alkene moiety of the dye monomer and R₁ is selected from: alkyl; aryl; benzyl; halogen; ester; acid amide; and, CN.

3. A detergent composition according to claim 2, wherein the organic bridging group is selected from: —CONR₄—; —NR₄CO—; —COOR₄—; —NR₄—; —O—; —S—; —SO₂—; —SO₂NR₄—; —N(COR₄)—; and —N(SO₂R₄)—; wherein R₄ is selected from: H; C1-C6 branched or linear alkyl; phenyl and benzyl groups; wherein R4 has 0 to 1 spacing units selected from: —O—; —S—; —SO₂—; —C(O)O—; —OC(O)—; and an amine.

4. A detergent composition according to claim 2, wherein the organic bridging group is selected from: —NR₄CO— and —CONR₄—.

5. A detergent composition according to claim 2, wherein R₄ is selected: from: H and Me.

6. A detergent composition according to claim 2, wherein the Y group is bound directly to a carbon atom of an aromatic ring of the dye.

7. A detergent composition according to claim 1, wherein the dye is an organic dye selected from the following chromophore classes: anthraquinone; azo; azine; triphenodioxazine; triphenyl methane; xanthene; and, phthalocyanin.

8. A detergent composition according to claim 7, wherein the organic dye is selected from the following chromophore classes: azo; anthraquinone; and, azine chromophore classes.

9. A detergent composition according to claim 1, wherein R₁ is selected from: H; Me; Et; Pr; CO₂C1-C4 branched and linear alkyl chains; phenyl; benzyl; CN; Cl; and, F.

10. A detergent composition according to claim 9, wherein R₁ is selected from: H; and, Me.

11. A detergent composition according to claim 1, wherein the dye-monomer is selected from: acid violet 1; acid violet 3; acid violet 6; acid violet 11; acid violet 13; acid violet 14; acid violet 19; acid violet 20; acid violet 36; acid violet 36:1; acid violet 41; acid violet 42; acid violet 43; acid violet 50; acid violet 51; acid violet 63; acid violet 48; acid blue 25; acid blue 40; acid blue 40:1; acid blue 41; acid blue 43; acid blue 45; acid blue 47; acid blue 49; acid blue 51; acid blue 53; acid blue 56; acid blue 61; acid blue 61:1; acid blue 62; acid blue 69; acid blue 78; acid blue 81:1; acid blue 92; acid blue 96; acid blue 108; acid blue 111; acid blue 215; acid blue 230; acid blue 277; acid blue 344; acid blue 117; acid blue 124; acid blue 129; acid blue 129:1; acid blue 138; acid blue 145; direct violet 99; direct violet 5; direct violet 72; direct violet 16; direct violet 78; direct violet 77; direct violet 83; food black 2; direct blue 33; direct blue 41; direct blue 22; direct blue 71; direct blue 72; direct blue 74; direct blue 75; direct blue 82; direct blue 96; direct blue 110; direct blue 111; direct blue 120; direct blue 120:1; direct blue 121; direct blue 122; direct blue 123; direct blue 124; direct blue 126; direct blue 127; direct blue 128; direct blue 129; direct blue 130; direct blue 132; direct blue 133; direct blue 135; direct blue 138; direct blue 140; direct blue 145; direct blue 148; direct blue 149; direct blue 159; direct blue 162; direct blue 163; and, food black 1 where the acid amide group is replaced by NH₂, wherein the one —NH2 of the dye is converted to —NH—C(O)—CH═CH2 or —NH—C(O)—C(Me)=CH2.

12. A detergent composition according to claim 2, wherein the dye-monomer is selected from the anthraquinione: 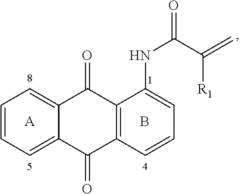
wherein the anthraquinione carries at least one sulphonate.

13. A detergent composition according to claim 12, wherein the A and B ring are further substituted by one or more groups selected from: NH₂; NHAr; NHR₅; NR₅R₆; OH; Cl; Br, CN, OAr; NO₂; SO₂OAr; Me; and, NHCOC(R₁)═CH₂, wherein R₅ and R₆ are independently selected from C1-C8 branched, cyclic or linear alkyl which may be substituted by OH, OMe, Cl or CN.

14. A detergent composition according to claim 12, wherein the dye has one SO₃⁻ group and the SO₃⁻ group is at the 2 position.

15. A detergent composition according to claim 14, wherein the 4 position is substituted with a substituent selected from: NH₂; NHR₅; NHAr, where Ar is phenyl or substituted phenyl, and the 5 and 8 position are H.

16. A detergent composition according to claim 1, wherein the comonomer is selected from: 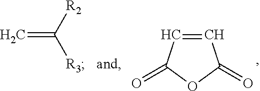
wherein R₂ and R₃ are independently selected from: H, C1-C8 branched, cyclic and linear alkyl chains, C(O)OH, CO₂C1-C18 branched and linear alkyl chains, —C(O)N(C1-C18)2; —C(O)N(C1-C18)H; —C(O)NH2; heteroaromatic, phenyl, benzyl, polyether, cyano, Cl and F.

17. A detergent composition according to claim 16, wherein R₂ and R₃ of the comonomer is further substituted by groups selected from: charged; and, uncharged organic, the further groups having a total molecular weight of less than 400.

18. A detergent composition according to claim 1, wherein detergent composition comprises a fluorescent agent.

19. A detergent composition according to claim 1, wherein detergent composition is granular.

20. A domestic method of treating a textile, the method comprising the steps of:
(i) treating a textile with an aqueous solution of the dye-polymer as defined in claim 1, the aqueous solution comprising from 10 ppb to 100 ppm of the dye-polymer; and, from 0.0 g/L to 3 g/L of a surfactant;
(ii) optionally rinsing; and,
(iii) drying the textile.

21. A domestic method of treating a textile according to claim 20, wherein the aqueous solution comprises from 0.3 to 2 g/L of a surfactant.

22. A dye-monomer, wherein the dye-monomer is selected from: acid violet 1; acid violet 3; acid violet 6; acid violet 11; acid violet 13; acid violet 14; acid violet 19; acid violet 20; acid violet 36; acid violet 36:1; acid violet 41; acid violet 42; acid violet 43; acid violet 50; acid violet 51; acid violet 63; acid violet 48; acid blue 25; acid blue 40; acid blue 40:1; acid blue 41; acid blue 43; acid blue 45; acid blue 47; acid blue 49; acid blue 51; acid blue 53; acid blue 56; acid blue 61; acid blue 61:1; acid blue 62; acid blue 69; acid blue 78; acid blue 81:1; acid blue 92; acid blue 96; acid blue 108; acid blue 111; acid blue 215; acid blue 230; acid blue 277; acid blue 344; acid blue 117; acid blue 124; acid blue 129; acid blue 129:1; acid blue 138; acid blue 145; direct violet 99; direct violet 5; direct violet 72; direct violet 16; direct violet 78; direct violet 77; direct violet 83; food black 2; direct blue 33; direct blue 41; direct blue 22; direct blue 71; direct blue 72; direct blue 74; direct blue 75; direct blue 82; direct blue 96; direct blue 110; direct blue 111; direct blue 120; direct blue 120:1; direct blue 121; direct blue 122; direct blue 123; direct blue 124; direct blue 126; direct blue 127; direct blue 128; direct blue 129; direct blue 130; direct blue 132; direct blue 133; direct blue 135; direct blue 138; direct blue 140; direct blue 145; direct blue 148; direct blue 149; direct blue 159; direct blue 162; direct blue 163; and, food black 1 where the acid amide group is replaced by NH₂, wherein the one —NH2 of the dye is converted to —NH—C(O)—CH═CH2 or —NH—C(O)—C(Me)=CH2.
